(19) United States
(12) Patent Application Publication
(10) Pub. No.: US 2025/0373757 A1
(43) Pub. Date: Dec. 4, 2025

(54) SETTINGS ADJUSTMENTS FOR A REMOTE VIDEO FEED

(71) Applicant: Lenovo (United States) Inc., Morrisville, NC (US)

(72) Inventors: John W. Nicholson, Cary, NC (US); Daryl C. Cromer, Raleigh, NC (US); Howard Locker, Cary, NC (US)

(21) Appl. No.: 18/680,284

(22) Filed: May 31, 2024

(51) Int. Cl. H04N 7/15

(52) U.S. Cl. CPC H04N 7/15

(57) ABSTRACT

One embodiment provides a method, the method including: receiving, at an information handling device of a user during a video session, a video feed occurring in substantially real-time and displaying at least one object; receiving, from the user, input adjusting at least one characteristic of the video feed via adjustment of a parameter of a device capturing the at least one video feed; and providing, from the information handling device, instructions to a remote information handling device capturing the video feed to adjust the at least one characteristic of the video feed Other aspects are claimed and described.

### BACKGROUND

Video conferencing requires two or more remote users to connect by sharing a video feed of each user over a communication medium, for example, a video conferencing application. This type of communicating has become common practice with advances in image capturing technology and increased internet capability and usage. When taking advantage of such a communication method, multiple variables can influence a quality of a meeting, and more specifically, a quality of a video feed being provided from a user to another user in communication and/or to a video conferencing application. Internet connection strength, versions of image capturing devices, information handling device in use, and/or the like, can influence how a user, or an attendee, of a video conference may view other users and may be viewed by the other users. Ideally, each user will have a crisp and clear video of themselves being provided to one or more other remote users, but because of the influence of multiple variables when connecting, that is not always the case.

### BRIEF SUMMARY

In summary, one aspect provides a method, the method including: receiving, at an information handling device of a user during a video session, a video feed occurring in substantially real-time and displaying at least one object; receiving, from the user, input adjusting at least one characteristic of the video feed via adjustment of a parameter of a device capturing the at least one video feed; and providing, from the information handling device, instructions to a remote information handling device capturing the video feed to adjust the at least one characteristic of the video feed.

Another aspect provides a system, the system including: a processor; a memory device that stores instructions that, when executed by the processor, causes the system to: receive, at an information handling device of a user during a video session, a video feed occurring in substantially real-time and displaying at least one object; receiving, from the user, input adjusting at least one characteristic of the video feed via adjustment of a parameter of a device capturing the at least one video feed; and providing, from the information handling device, instructions to a remote information handling device capturing the video feed to adjust the at least one characteristic of the video feed.

A further aspect provides a product, the product including: a computer-readable storage device that stores executable code that, when executed by a processor, causes the product to: receive, at an information handling device of a user during a video session, a video feed occurring in substantially real-time and displaying at least one object; receive, from the user, input adjusting at least one characteristic of the video feed via adjustment of a parameter of a device capturing the at least one video feed; and providing, from the information handling device, instructions to a remote information handling device capturing the video feed to adjust the at least one characteristic of the video feed.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing instructions to a remote device to adjust at least one characteristic of a video feed by receiving input from a user for adjusting a characteristic of the video feed.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When sharing a video feed of yourself, or of a user, over a video conferencing application and/or any type of live-video sharing application, quality can fluctuate based upon multiple variables. Some variables include for example, accessible internet bandwidth, a version of an image capturing device, the location from which a user is attempting to access a conferencing application, and/or the like. Quality of a video feed is of utmost importance when attempting to access video conference and/or share a live video feed of a user. Image quality issues may still arise even when a strong, or dependable, internet connection is available. Image quality issues may stem from video feed characteristics associated with a user providing their video feed. For example, brightness level issues, shadows present, and/or the like, may be present when a video feed is being shared. In conventional methods, adjusting of image characteristics at a user device (i.e., the device that is capturing the video feed and transmitting it to another user) is usually performed to correct such issues. Traditionally, a user can preview a video feed prior to sharing the video feed to additional remote users, and when an image quality issue is noticed, the user may adjust image characteristics in the video feed settings to correct the recognized issue.

However, an image quality issue is not always noticeable to the user providing the video feed, but rather, a viewer, or one or more of the remote users present in a video conference who may witness an image quality issue of a user's provided video feed. This may occur because the user is focused on presenting and not on the quality of the video preview, may have the preview window turned off and may not see the quality issue, may not notice temporal issues, may be based upon actions of the user that are not evident when the user is looking at the video preview, and/or the like. Conventionally, in order to combat these image quality issues not seen by the user providing the video feed requires users viewing the video feed to notify the user that there is an issue with their video feed. The presenting user may then attempt to adjust video feed characteristics on their device as instructed by the viewing users and eventually confirmed by the viewing users. For example, if the user providing the video feed has a choppy video stream, a viewing user may notify the user providing the stream and an adjustment to a connection may be made, for example, transitioning from a cellular data connection to a Wi-Fi connection.

As another example, if the video feed of a user is too dark to a point where a viewing user cannot see the user providing the feed, a viewing user may notify the user providing the video feed of the image quality issue. The user providing the video feed may thereafter adjust brightness settings associated with the video feed being provided until a confirmation from a viewing user that the user providing the video feed is clear. In any conventional situation, the recognition, notifying, adjusting, and confirming of a change to one or more settings of a video feed provided by a user will disrupt, and potentially detour, a video conference until the quality issue is accounted for. This can be seen as a waste of quality meeting time. Additionally, or alternatively, in a more advanced yet conventional method, a production team on a set and/or monitoring the quality of a video feed may be present and in charge of adjusting parameters in order to maintain a high-quality video feed. As one can imagine, a traditional user in a tele-conferencing or other video session does not have access to such resources. Therefore, the user will have to make the adjustments themselves. Thus, what is needed is a system and method that may permit adjusting a video feed of user by one or more remote users viewing the video feed to ascertain that a quality level of a video feed is met and adjusted without disrupting the video conference.

Accordingly, the described system and method provides a technique for providing instructions to a remote information handling device capturing a video feed of a user for adjusting at least one characteristic of the video feed. The system may receive at least one video feed occurring in substantially real-time and displaying an object at an information handling device of a user during a video session. The system may then also receive input adjusting at least one characteristic of the video feed from a remote user. After receiving the video feed of a user, and then receiving the input to adjust a characteristic of the video feed for the user from a remote user, the system may then provide the instructions for adjusting the characteristic of the video feed. A remote user viewing the video feed of the user may adjust characteristics of the video feed without the knowledge of a user providing the video feed. Thus, any disruption to a video session that may traditionally occur are avoided. Such a system and method establish an ability to permit adjustments to a video feed by a user viewing a video feed rather than relying on the user providing the video feed, which may otherwise result in disruptions in video conferences and remote meetings.

The illustrated example embodiments will be best understood by reference to the figures. The following description is intended only by way of example, and simply illustrates certain example embodiments.

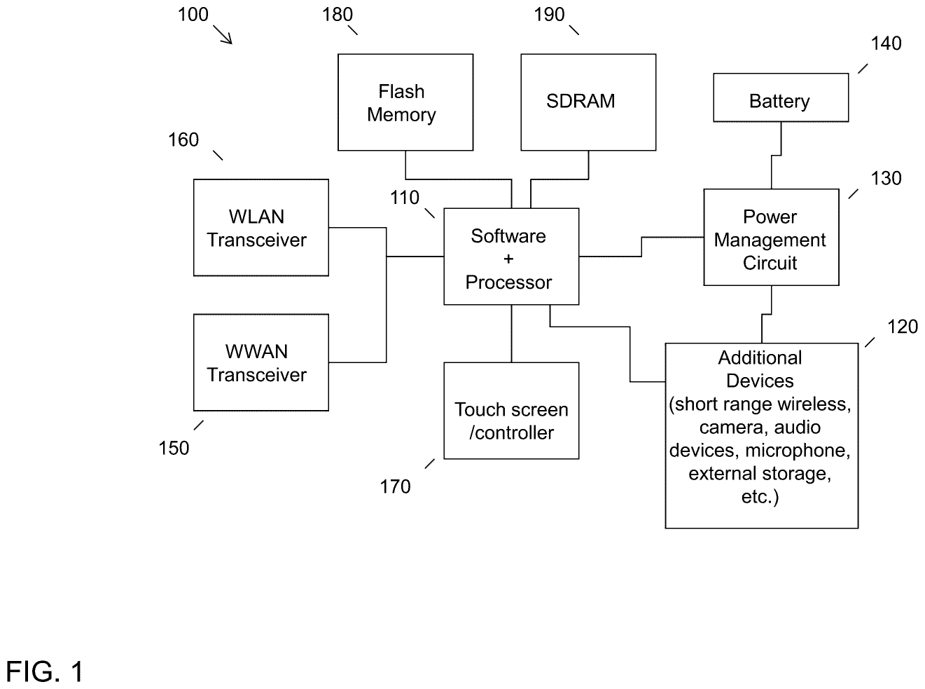

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

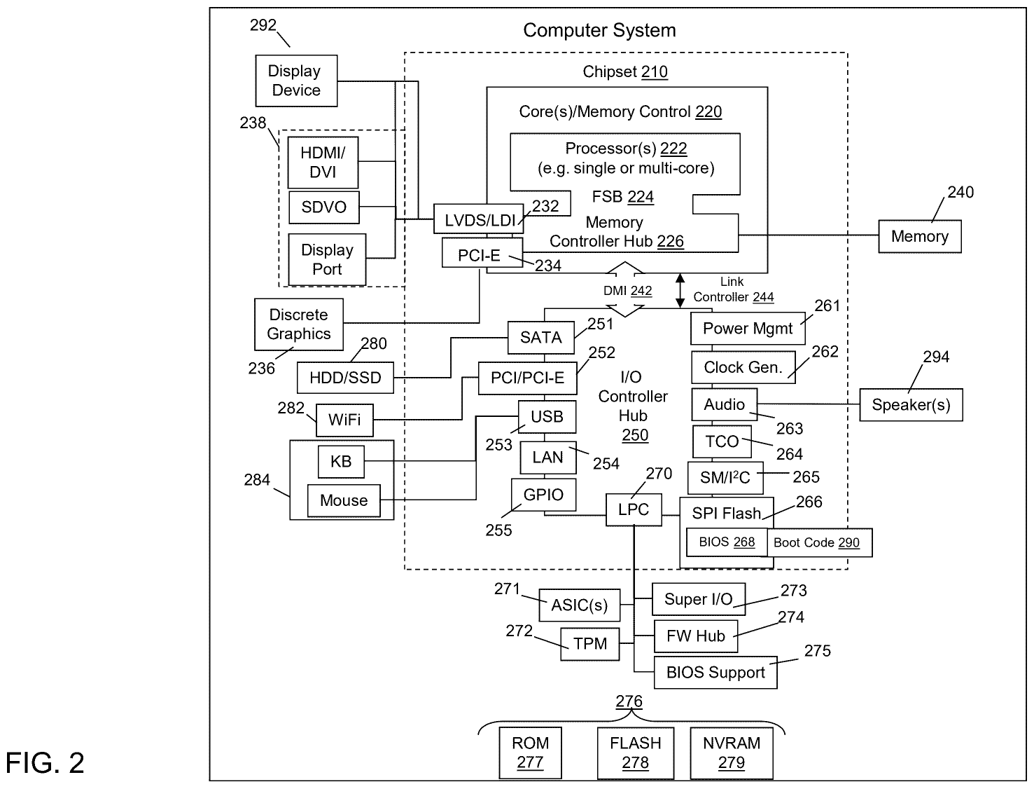

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be utilized for connecting to or participating a video conference. For example, the circuitry outlined in FIG. 1 may be implemented in a tablet or smart phone embodiment, whereas the circuitry outlined in FIG. 2 may be implemented in a personal computer embodiment.

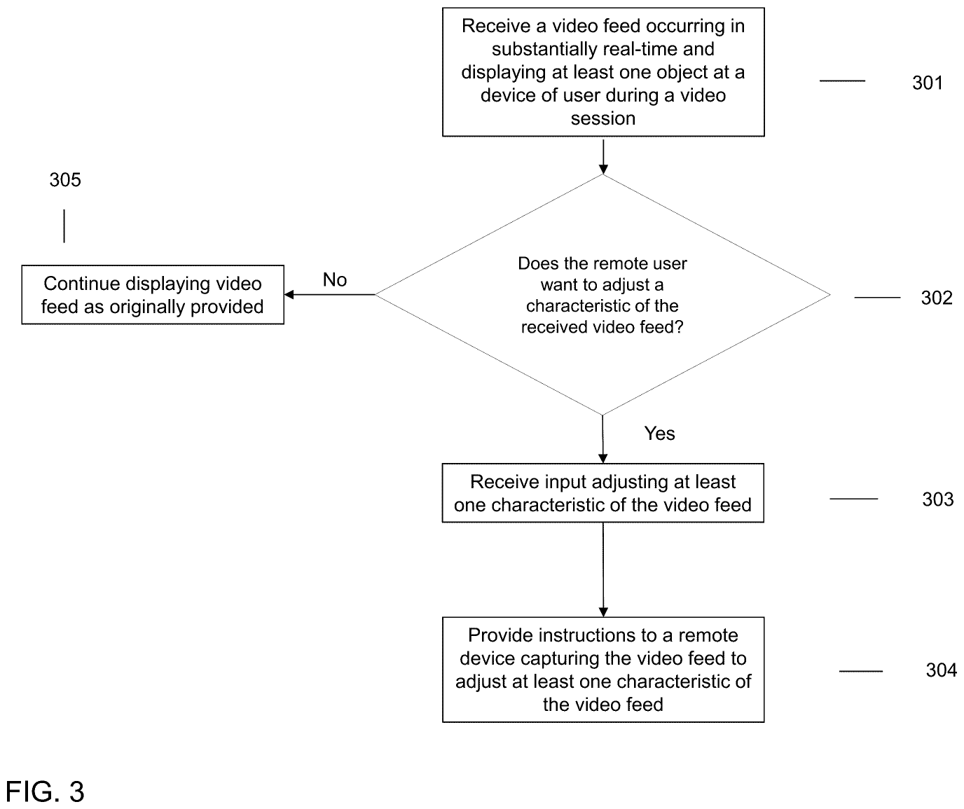

FIG. 3 illustrates an example method for providing instructions to a remote device to adjust at least one characteristic of the video feed by receiving input from a user for adjusting a characteristic of the video feed. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to providing instructions to a remote device to adjust at least one characteristic of the video feed. Additionally, the video feed characteristic system includes modules and features that are unique to the described system.

The activation of the video feed characteristic system may be manual, where a user provides an input indicating that the video feed characteristic system should be activated, or automatic where the video feed characteristic system detects a trigger event indicating that the system should be activated. Example trigger events include detection of activation of a video conferencing application, activation of an image capturing device, and/or the like. For example, the system may identify that a user is attempting to access a scheduled video conference through their digital calendar. This activation of a video session, or conferencing application, may be considered a trigger event that activates the video feed characteristic system.

The video feed characteristic system may be a standalone system, may be accessible through other computing devices, and/or a combination thereof. For example, the video feed characteristic system may be a standalone system that can be accessed by a user and/or may be or provide an application that is accessible by a user on another computing device. The video feed characteristic system may be accessible using any type of computing device, for example, personal computer, laptop computer, smartphone, tablet, smartwatch, head-mounted display, smart television or other smart appliance, augmented reality device, virtual reality device, and/or the like. Thus, the video feed characteristic system may be accessible locally using a computing device where the video feed characteristic system is installed and/or may be accessible remotely through another computing device. However, the video feed characteristic system may be located and operate on a different information handling device to perform the described steps.

The video feed characteristic system may have an associated graphical user interface. The graphical user interface may be provided on a display or monitor, which may or may not be associated with the video feed characteristic system. In other words, the video feed characteristic system may have a dedicated display or monitor or may be accessible using any display or monitor. In either case, the video feed characteristic system may provide instructions to generate and display the graphical user interface on the display device being used to access the video feed characteristic system. The graphical user interface may also be updated and managed based upon instructions provided by the video feed characteristic system. In other words, the video feed characteristic system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the video feed characteristic system, for example, the video feed characteristic system characteristics associated with a video feed that may be adjusted to correct a quality issue of a video feed. The graphical user interface may allow for a user to modify image characteristics of a video feed, modify audio characteristics of a video feed, and/or the like. The graphical user interface may also allow a user to provide notifications to a user providing the video feed describing what changes have been made to the video feed while the video feed is ongoing in substantially real-time.

Within the graphical user interface, the user may also identify, select, remove, and/or otherwise modify characteristics that may be present during the sharing of a video feed over a communication medium. The user may also access information related to these devices, for example, information identifying device identifiers, device components or sensors, the location of the devices, and/or the like. Additionally, the graphical user interface may allow a user to adjust a variety of characteristics while a video feed is ongoing. Input may be provided by the user using any type of input modality, including, but not limited to, mechanical input (e.g., keyboard input, mouse input, etc.), touch input, audible or voice input, gesture input, haptic input, input from an augmented reality or virtual reality device, and/or the like.

The graphical user interface may also provide displays that display the video feed of a user. The video feed characteristic system may have default or system-wide settings that are the same across different users, systems, applications, and/or the like, until the information is adjusted or otherwise changed. It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The video feed characteristic system may utilize one or more artificial intelligence models in performing adjustments to at least one characteristic of the video. Artificial intelligence models may also be used for steps within a step. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the video feed characteristic system or may be a model that is created from scratch. Since the video feed characteristic system is used in conjunction with an information handling device of user accessing a video session via a communication medium, some models that may be utilized by the system are image analysis models, entity identification models, similarity identification models, analysis models, filtering models, classification models, and/or the like. The model may be trained using one or more training datasets. Additionally, as the model is deployed, it may receive feedback to become more accurate over time. The feedback may be automatically ingested by the model as it is deployed. For example, as the model makes predictions regarding the video feed and characteristics, if a user provides feedback, makes adjustments to the video feed or characteristics, and/or otherwise provides some indication the prediction is incorrect, the model ingests this feedback to refine the model, thereby becoming more accurate over time.

On the other hand, as the model makes predictions, if no feedback is received that would indicate that the predictions were incorrect or needed to be changed, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like. Thus, the model becomes more accurate over time through learning by the model based upon predictions made by the model over time.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The video feed characteristic system may include different components for carrying out different functions of the system, including different steps to be performed. These components may be hardware components or software components. Some hardware components may include image capture sensors, audio capture sensors, displays, and/or the like. The image capture sensors can be used to obtain a video feed, and the audio sensors can be used to obtain audio data supplied while an image capture sensor is capturing a video feed. The system may also include one or more displays. One display for a remote user is required for viewing of the at least one video feed being supplied to the remote user. The user providing the video feed may also have a display or monitor.

The described system and method are in contrast to traditional video feed alteration techniques in which the user providing the video feed is the only user than may interact with characteristics of their supplied video feed. To facilitate video feed alterations using traditional techniques, the user providing a feed must stop what they are doing and manually make adjustments to a video feed while receiving feedback from at least one remote user also in attendance of the virtual meeting. On the other hand, using the video feed characteristic system permits a remote user in attendance at the virtual meeting to make adjustments to a video feed of a providing user to correct a quality issue being viewed by the at least one remote user without the need of disrupting a user providing a video feed and presenting during a video conference. Additionally, when a user is not presenting but a quality issue is present in their video feed, the video feed characteristic system allows a remote user to adjust characteristics of a user's video feed until the quality issue is corrected. For clarity, the user providing the video feed will be referred to as the providing user or the user providing the video feed. The user receiving or viewing the video feed will be referred to as the remote user. However, the terminology to describe the information handling devices will be with respect to the user being described. For example, if the remote user is providing adjustments to adjust a video feed, the adjustments are being provided to a remote information handling device, which is the information handling device of the providing user, because the information handling device is remote to the remote user.

A software component that is utilized in the system is the profile of the user. The profile of the user includes previously stored behaviors or adjustments of the user video conferencing, or a video session, space. Each user providing a video feed has an associated user profile that may store video session data. Each of these profiles will be referred to as a user profile for ease of readability. Thus, a user profile includes video feed characteristics for a video feed that may be provided, and potentially preferences for viewing video feeds provided by other users. Accordingly, the profile of the user may contain more than one set of video feed characteristics to account for the video feed of themselves, as well as characteristics for video feeds a user may commonly interact with.

To create a user profile the system is essentially set in a training mode. The training mode allows the system to capture adjustments of a user made to video feeds, either their own video feed or remote video feeds. Before adjusting characteristics of a video feed, a foundation of a video feed may be established. This provides the system with a baseline of what objects are contained within a video feed. Once a user enters a video session, the video feed characteristic system monitors the user and collects information about the adjustments of the user made within a video session. In order to accurately identify adjustments of the user, the system must be able to record user preferences while present in a video session. Accordingly, the system utilizes components or devices that can capture the information (e.g., image information and input information) related to adjusting characteristics of a video feed.

Artificial intelligence models can be used when providing instructions to a remote information handling device to adjust characteristics of a captured video feed. For example, the models can be used to identify quality issues present in a video feed and the associated characteristic of the video feed to correct the quality issue. Artificial intelligence models can also be used in the capturing of the user adjustments while a video session in ongoing. For example, the models can be used to analyze the inputs of the user to generate a user profile and then used to create a profile of each remote user that a user interacts with. Additionally, the artificial intelligence models can be used to perform other steps, assist in performing some of the steps, and/or the like.

At 301, the system may receive at least one video feed occurring in substantially real-time and displaying at least one object at an information handling device of a user during a video session. For clarification, the user viewing the at least one video feed is the remote user. In other words, the system receives at least one video feed and displays it at an information handling device of a remote user. A video feed refers to a capture of continuous consecutive images of a space. The video feed is then transmitted to the information handling device of the remote user. Sharing a video feed between two users, at a minimum a presenting user and a viewing user, requires the users to utilize a communication medium that they are both connected to, for example, a video conferencing application, a video call application, a social media application, and/or the like. Generally, within the video conferencing or other video application or video session, the at least two users will both act as a presenting user and viewing user since both may share a video feed of themselves to be viewed by the other user. Thus, each participant may be both transmitting and receiving video feeds. However, this is not strictly necessary, as one user may choose to only receive video feeds and not transmit a video feed. Viewing at least one video feed during a video session 301 requires an information handling device that employs a display. Either operatively or integrally coupled to the information handling device, a display will permit the viewing of a video feed.

When receiving the at least one video feed occurring in substantially real-time at 301, a video feed may capture and transmit image data that is occurring in the moment to at least one user viewing the video feed. In other words, occurring substantially in real-time at 301 describes receiving a live video feed from a user. However, due to transmission rates and processing times, the live video feed may be slightly delayed (e.g., fractions of a second, a second, a few seconds, etc.) as compared to the real-world environment. Additionally, or alternatively, the receiving of a video feed in substantially real-time may include a buffer, and/or lag time, that may provide a video feed with a delay. This may be present for a variety of reasons, for example, in case a stream needs to be cut for any reason, a video stream may be stopped before an issue arises, and/or the like. However, even with a worked in lag time for a video feed, this is a short period of time, for example, a few seconds. Therefore, the video feed occurring in substantially real-time encompasses this idea.

When receiving at least one video feed at an information handling device during a video session at 301, the system may receive an indication to transmit the at least one video feed in a variety of ways, for example, by opening a scheduled calendar event, accessing a video session via an email invitation, opening a video session application, receiving a trigger event to transmit a video feed, and/or the like. The information handling device of the user that is utilized to access a video session may include at least one application and/or or a communication medium that permits the sharing of video feeds across multiple devices.

Receipt of the at least one video at 301 is by one or more remote users accessing a video session over a communication medium through their information handling device. The video feed may include at least one object which includes whatever is captured in the at least one video feed received. The at least one object that is captured in the video feed may be known as the region-of-interest. For example, the at least one object being displayed, or the region-of-interest, at 301 may be a user's face, a white board containing data, an application window that is being shared from a user's information handling device, other objects within an environment or space, and/or the like. The video feed may also include distorted or adjusted objects, for example, a blurred background, a modified background, and/or the like. The adjusted portion of the video feed may be determined to outside of the region-of-interest, and therefore, deemed as secondary and/or insignificant data. Thus, the received at least one video feed will display captured image data from one user device to at least one other user device and may include some adjustments to the captured image data. For ease of readability, the at least one object used and/or the region-of-interest is a human face. However, this is intended to be a non-limiting example as many other different objects can be captured and transmitted in the video feed.

After receiving the at least one video feed, a remote user viewing the video feed may then determine if the remote user wants to make any changes or adjustments to one or more characteristics of the received video feed at 302. The remote user may want to make changes or adjustments if the remote user identifies an issue with the received video feed or simply because the remote user wants to make an adjustment to the video feed. A remote user may determine that the video feed being provided from a user to the remote user is provided with less-than-optimal viewing characteristics, either due to an issue or based upon the perception of the remote user. In other words, the remote user may identify that an issue is present in the video feed that may negatively influence the viewing of video feed being received. Alternatively, the remote user may simply identify a change that the remote user wants made to the display of the received video feed. As mentioned previously, a user sharing a video feed may not perceive that a change needs to be made; whereas, at least one remote user may perceive that such a change needs to be made. An issue of the video feed may be, for example, a choppiness in the video feed, a color balance issue of the video feed, a presence of shadows and/or brightness issue that makes it hard to interpret what is occurring in the video feed, an unpreferred viewing aspect, and/or the like. Thus, adjustments may be identified that would assist in addressing these issues. Additionally, similar adjustments can be made, even if such issues are not present.

When it is determined, at 302, that the remote user does not want to make any changes to the received video feed, the system may continue to display the video feed as originally provided at 305. In other words, the system may continue to provide the video feed without any adjustments being made to the video feed.

On the other hand, if the remote user does want to make an adjustment to the received video feed, the determining, at 302, may include receiving input, from the remote user, adjusting at least one characteristic of the video feed at 303. Adjustment of the video feed includes adjusting a parameter of the device that is capturing the video feed. In other words, adjustment of the video feed is done much like a user would adjust their own video feed. For example, if a user providing a video feed wanted to adjust a brightness of the video feed, the user would access a user interface that allows the user to select and perform adjustments to the brightness of the video feed. This does not simply result in a post-processing of an image or video feed, but rather changes the parameters of the device for capture of the image or video feed. Accordingly, when the remote user provides adjustments to be made to the video feed, the adjustments are treated by the device of the user providing the video feed as if the user of the device providing the video feed were providing the adjustments. Thus, the adjustments are made to the device or parameters of the device and not simply to the images or video feed after it is captured by the device.

Prior to the remote user providing input adjusting at least one characteristic of the video feed at 303, the user may determine at least one characteristic to account for the issue or preference identified by the remote user. For example, if a video feed received at 301 is determined to be too dark, then the remote user may provide an input for adjusting a brightness characteristic of the video feed received. This input is received by the system at 303. As another example, the remote user may identify the color balance of the video feed is off, and may provide input to adjust the color balance. The input may be provided in the graphical user interface, which may be a part of the video session application or may be a secondary window that is visible during the video session.

When determining if there is a quality issue or that a user preference varies from the characteristic of the received video feed at 302, the system may utilize an artificial intelligence model to determine a quality issue that is present within the video feed or a change that needs to be made, and thereafter, identify at least one video feed characteristic to adjust in order to address the issue or user preference at 303. As mentioned previously, an artificial intelligence model may be trained with video feeds that adjusted based upon issues or user preferences and video feeds that have not been adjusted. From this training and continued use of the artificial intelligence technique employed by an information handling device of a user, the system may refine the artificial intelligence technique when determining that an adjustment should be made. If an adjustment is identified, the model may identify at least one characteristic that may be adjusted to account for the identified adjustment of the new video feed received. When utilizing such an artificial intelligence technique, the system may determine issues or adjustments at 302 and receive input to adjust the characteristic at 303 without the need of user interaction. In other words, the issue/adjustment may be identified automatically and the provision of the input to adjust the characteristic may occur automatically.

Additionally, or alternatively, the system may be in communication with additional devices outside of the information handling device of a user providing a video feed over a video conferencing application and the information handling device of at least one remote user. These additional devices, for example, image capture sensors, audio capturing sensors, display devices, and/or the like, may be in communication with a device of the user providing the video feed, and may assist an artificial intelligence model to determine if there is an issue or adjustment to be made in the received video feed. For example, a camera may be in the space of the remote user and may capture the video feed, provide the video feed to the artificial intelligence model, and the model may then analyze the video feed to identify any possible issues or adjustments to be made. Upon identifying an issue or adjustment, the model may provide input to adjust a characteristic to address the issue(s) or adjustment.

Thus, after determining there is an issue or an adjustment to be made in the received video feed, the system may receive input adjusting at least one characteristic of the video feed of the user either automatically, for example, from an artificial intelligence model, based upon preferences of a remote user, and/or the like, or from a remote user manually providing the input, for example, into a graphical user interface, by providing voice input, and/or the like. When adjusting at least one characteristic of the video feed, the system may adjust the video feed prior to subsequent portions of the video feed being received at the information handling device of a remote user. In other words, adjusting the at least one characteristic may occur in real-time so when viewing the video feed, the identified issue is addressed and fixed or the desired adjustment is made for subsequent portions of the video feed while the video feed is transmitting. This is an advancement over traditional adjustments for video feed characteristics that may only occur in subsequent virtual meetings and/or adjustments to a video feed that may need to occur when a video feed is not active.

Adjusting at least one characteristic of the video feed may be in view of a plurality of remote users accessing a video session over a video conferencing application. In a system that includes a one-on-one virtual meeting comprising only two users, the adjusting of at least one characteristic of a video feed may be reliant on a video feed being displayed on a single additional information handling device. Thus, when adjustments are to be made, they are based upon inputs received from the single remote viewer. However, it is common video session practice to include more than two users in a virtual meeting.

When there are more than one remote users, each associated with their own information handling device, different remote users may want to make different adjustments to the received video feed. For example, different remote users may select a different region-of-interest within the received video feed (e.g., a face, a whiteboard, a presentation object, a monitor, etc.). Having different region-of-interest selected can result in having different video feed characteristics for each of the remote users. For example, a location of a whiteboard in an environment may result in a bright area, whereas the location of a face in an environment may have shadows. Thus, the remote user viewing the whiteboard may think the video feed is too bright, whereas the remote user viewing the face may think the video feed is too dark. As another example, remote users may simply have different perceptions of the characteristics of a video feed, even if viewing the same region in the video feed.

In such a situation, adjustments made to the video feed by one remote user, may negatively influence the video feed being viewed by other of the remote users. Additionally, or alternatively, adjusting a characteristic may be associated with a user preference when viewing a video feed. Adjusting a characteristic based on the preference of one remote user may influence the video feed being viewed by an alternate remote user, potentially straying further from the alternate user's viewing preference. Accordingly, before acting upon input including adjustments to characteristics of the video feed, the system may determine whether a threshold level of adjustment of at least one characteristic of the video feed has been received before actually making the adjustment in order to accommodate the fact that multiple users are viewing the video feed of the same presenting user. In other words, because the input adjusting a characteristic actually adjusts the video feed of the presenting user, all users who are receiving the video feed of the presenting user will have the adjusted video feed.

When receiving the input adjusting at least one characteristic of the video feed, the system may weigh a level of adjusting provided from each remote user and determine a level of adjusting permitted. Thus, the system attempts to maximize the viewing experience for all remote viewers, but due to the fact that there are multiple remote users, not all remote users may have an optimal or perfect viewing experience in an effort to create the best viewing experience for all remote users. For example, referring back to the darkness example, if a user viewing a quality issue attempts to increase the brightness of the video feed to overcome the darkness, a user that is originally viewing a video feed without the darkness issue will then be provided a video feed that is brighter. Therefore, the system may determine a threshold level of adjustment of a characteristic that may be performed in order for each remote user viewing the video feed of the presenting user so that all the remote users can have a reasonable viewing experience. Thus, the system may set threshold values that allow a remote users to adjust a characteristic up to the threshold value. The threshold value may be determined based upon a number of remote users, how many remote users are providing input to adjust the same characteristic, a role of the remote user providing the input (e.g., supervisors may be allotted more adjustment than other remote users, other presenters may be allotted more adjustment than other remote users, etc.), and/or the like.

Additionally, or alternatively, in the system, an artificial intelligence model may be utilized to determine a permitted threshold level of adjustment to at least one characteristic in real-time. The model may perform calculations based upon video feeds from the remote users that identify a maximum modification to a characteristic that does not result in a poor viewing experience for another of the remote users. The system may also use input provided by the remote users to identify the threshold value. For example, if one remote user provides input that increases a characteristic and, after the characteristic is adjusted, receives input from another remote user decreasing the characteristic, the system may use this information to identify the threshold value for adjustment of the characteristic. In other words, the system attempts to identify the point at which the characteristic was adjusted too far that resulted in the other remote user providing input to correct the characteristic. This point may then be used as the threshold value.

After receiving input adjusting at least one characteristic of the video feed at 303, the system may provide instructions to a remote device capturing the video feed to adjust at least one characteristic of the video feed at 304. In other words, the system may provide instructions for adjusting at least one characteristic to the device of the user supplying the video feed to the at least one other remote user. Provision of the instructions at 304 includes instructions for adjusting at least one characteristic of the video feed based upon the input received from the remote user(s). Providing instructions to a remote device capturing the video feed includes adjusting a video capturing setting. In the system, and as mentioned previously, a characteristic of the video feed may be associated with a setting of the video capturing device, for example, brightness settings, color settings, focus settings, and/or the like. While a video capturing device has been used as the example here throughout, it should be noted that since video feeds generally include audio, the issue or adjustment in the video feed may also include an issue or adjustment in the audio portion of the video feed. Accordingly, the input adjusting the characteristic may be an input adjusting the audio portion and the instructions provided to the remote device may include instructions to an audio capture device.

Providing instructions to a remote device capturing the video feed may include receiving confirmation from at least one of the other devices to adjust the at least one characteristic. As mentioned previously, the system may be in communication with a plurality of devices outside of the devices each user utilizes to access a video session. The additional devices may confirm that the received inputs for adjusting at least one characteristic are needed, and may assist in providing instructions to the remote device capturing the video feed to adjust at least one characteristic of the video feed. Additionally, or alternatively, in a situation including more than one remote user, the confirmation received from at least one of the other devices to adjust the at least one characteristic may be provided by one or more additional remote users, and may provide instructions to a remote device capturing the video feed when a predetermined threshold of confirmations is met. As mentioned previously, since at least one of a plurality of devices may view a video feed at a level having no issues or no desired adjustments, a threshold level of confirmations for adjusting the at least one characteristic of a video feed may be required to ascertain that all users viewing the video feed will maintain a pleasant viewing of the video feed with an adjustment to at least one characteristic.

The system may also record instructions provided to a remote device capturing the video feed. In the system, a user profile associated with a remote device may be recognized by the system, and upon providing instructions, the system may save instructions for the remote information handling device. These instructions may then be detected when a subsequent video session is occurring with the remote information handling device. In the system, these instructions may be saved in a user profile. Additionally, or alternatively, in the system, the instructions may be saved strictly in reference to the remote device utilized by a user. Therefore, when any user utilizes a remote device with saved instructions, the instructions may be referenced and potentially implemented upon recognition of the use of the device.

Further, in the system, when it is determined that the system will implement instructions upon detection of a subsequent video session, the system may apply these adjusted characteristics upon activation of the information handling device. Implementation of the instructions may be based upon a context surrounding the device accessing the video session. A context surrounding the devices may be determined by at least one sensor of the information handling device, by use of additional devices in communication with the information handling device, and/or the like. A context of the information handling device may include, for example, location data of the remote device capturing the video feed of user, an environment of the remote device, a time of day of the video feed, a season of the video feed, and/or the like. The context may influence some of the characteristics of the video feed, for example, brightness, color balance, and/or the like. Thus, the identified context may be any factor of the environment where the remote device is that may influence a characteristic of the video feed.

Accordingly, the system may account for the context when providing a video feed from a remote device. For example, if a context of the remote device capturing the video feed is determined to be outside on a sunny day, the system may adjust at least one characteristic of the video feed associated with brightness to account for the brightness of the environment. Additionally, or alternatively, in the system, when implementing the instructions upon detection of a subsequent video session, instructions may be based upon the detection of a user as a participant in the video session. As mentioned above, referencing a user profile may result in a system adjusting at least one characteristic when the user is detected as a participant.

The recognition of a device used previously and/or a user as a participant may not immediately influence at least one characteristic of the video feed received. Rather, in the system, the at least one characteristic adjustment may be temporary adjustment. A temporary adjustment may be implemented as a standalone adjustment and not utilized in the future. A user may include a notification to the system that an adjustment to a characteristic is either temporary or intended to be saved and referenced again, either in relation to the user as a participant or the remote device capturing the video feed.

Additionally, or alternatively, when providing instructions, the provision of the instructions may be performed iteratively upon subsequent detections of criteria resulting in adjustment of the at least one characteristic. In other words, instructions to adjust at least one characteristic of the video feed may be applied in stages based upon a determined context of the user and the remote device capturing the video feed. For example, a saved adjustment instruction associated with a user may include that a user is routinely in a darker room and the instruction is to increase brightness of the video feed. However, upon detection of the context of the user being in a brighter room than normal, the system may elect to not adjust a brightness setting of the remote device capturing the video feed. As the example continues, if the user then transitions to a room that is dark, the system may elect to implement the saved instruction to increase the brightness setting of the video feed.

In the system, adjusting of the at least one characteristic of a video feed may occur without the presenter of the video feed knowing. This adjusting of at least one characteristic may reduce disruptions in a video session while increasing quality of a video feed being provided to at least one remote user in the video session. An artificial intelligence model may be applied in a variety of ways in order to assist with determining when an issue of the video feed is present or an adjustment should be made, identifying at least one characteristic to be adjusted, supplying instructions to adjust the at least one setting associated with the at least one characteristic, and performing the adjusting. Further, in the system, the artificial intelligence model may recognize characteristic adjusting patterns associated with a user, a context of a user, an information handling device, a context of an information handling device, and/or the like, to ascertain those adjustments made to characteristics of the video feed and settings of the remote device capturing the video to increase and/or maintain an quality of the video feed being displayed.

As an overall example, a presenting user and a remote user may be within a video conference. The remote user may identify that the color balance of the video feed of the presenting user is unpleasant. For example, the remote user may identify that the video feed has a blue hue. The remote user may provide, within a graphical user interface, input that adjusts the color balance to remove the blue hue. The remote user may be provided with a preview that identifies how the video feed would look as the user is providing input to adjust the characteristic. Alternatively, as the remote user is providing the input, the video feed may be being adjusted in real-time and the remote user may see the resulting video. In the case of a preview being provided, when the remote user is happy with the adjustment, the remote user may provide an input indicating that the adjustments should be implemented, for example, by selecting a transmit icon, selecting a confirm icon, pressing a particular key on the keyboard, and/or the like. Upon identifying the remote has providing an indication that the adjustments should be implemented, either based upon receiving the input based upon the preview or while the user is making the adjustment to the video in real-time, the system provides instructions to the device of the presenting user to adjust the characteristic on the device of the presenting user. Accordingly, subsequent video will have the adjustments as identified by the remote user.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device of a user during a video session, a video feed occurring in substantially real-time and displaying at least one object;
receiving, from the user, input adjusting at least one characteristic of the video feed via adjustment of a parameter of a device capturing the at least one video feed; and
providing, from the information handling device, instructions to a remote information handling device capturing the video feed to adjust the at least one characteristic of the video feed.

2. The method of claim 1, wherein adjusting the at least one characteristic of the video feed comprises adjusting the parameter of the device prior to subsequent portions of the video feed being received at the information handling device.

3. The method of claim 1, wherein the providing instructions comprises providing instructions that adjust a video capture setting of the remote information handling device.

4. The method of claim 1, wherein a video session comprises other devices in addition to the information handling device and the remote information handling device and wherein the providing the instructions is responsive to receiving confirmation from at least one of the other devices to adjust the at least one characteristic.

5. The method of claim 4, wherein the receiving confirmation comprises receiving confirmation from a predetermined threshold of the other devices and wherein the providing instructions is performed when the predetermined threshold is met.

6. The method of claim 1, comprising saving the instructions for the remote information handling device and implementing the instructions upon detection of a subsequent video session.

7. The method of claim 6, wherein the implementing the instructions upon detection of a subsequent video session is based upon detecting a context for the subsequent video session having similar characteristics to a context of the video session.

8. The method of claim 6, wherein the implementing the instruction upon detection of a subsequent video sessions is based upon detecting the user as a participant in the video session.

9. The method of claim 1, wherein the providing instructions is performed iteratively upon subsequent detections of a criteria resulting in adjustment of the at least one characteristic.

10. The method of claim 1, wherein the at least one characteristic of the video feed comprises at least one of: an image characteristic and an audio characteristic.

11. A system, the system comprising:
a processor;
a memory device that stores instructions that, when executed by the processor, causes the system to:
receive, at an information handling device of a user during a video session, a video feed occurring in substantially real-time and displaying at least one object;
receiving, from the user, input adjusting at least one characteristic of the video feed via adjustment of a parameter of a device capturing the at least one video feed; and
providing, from the information handling device, instructions to a remote information handling device capturing the video feed to adjust the at least one characteristic of the video feed.

12. The system of claim 11, wherein the adjusting the at least one characteristic of the video feed comprises adjusting the parameter of the device prior to subsequent portions of the video feed being received at the information handling device.

13. The system of claim 11, wherein the providing instruction comprises providing instructions that adjust a video capture setting of the remote information handling device.

14. The system of claim 11, wherein the video conferencing application comprises other devices in addition to the information handling device and the remote information handling device and wherein the providing the instructions is responsive to receiving confirmation from at least one of the other devices to adjust the at least one characteristic.

15. The system of claim 14, wherein the receiving confirmation comprises receiving confirmation from a predetermined threshold of the other devices and wherein the providing instructions is performed when the predetermined threshold is met.

16. The system of claim 11, comprising saving the instructions for the remote information handling device and implementing the instructions upon detection of a subsequent video session.

17. The system of claim 16, wherein the implementing the instructions upon detection of a subsequent video session is based upon detecting a context for the subsequent video session having similar characteristics to a context of the video session.

18. The system of claim 16, wherein the implementing the instruction upon detection of a subsequent video session is based upon detecting the user as a participant in the video stream.

19. The system of claim 11, wherein the providing instructions is performed iteratively upon subsequent detections of a criteria resulting in adjustment of the at least one characteristic.

20. A product, the product comprising:
a computer-readable storage device that stores executable code that, when executed by a processor, causes the product to:
receive, at an information handling device of a user during a video session, a video feed occurring in substantially real-time and displaying at least one object;
receive, from the user, input adjusting at least one characteristic of the video feed via adjustment of a parameter of a device capturing the at least one video feed; and
providing, from the information handling device, instructions to a remote information handling device capturing the video feed to adjust the at least one characteristic of the video feed.
